(19) United States
(12) Patent Application Publication
(10) Pub. No.: US 2024/0283067 A1
(43) Pub. Date: Aug. 22, 2024

(54) Nonaqueous Electrochemical Battery Containing A Sealing Member

(71) Applicant: Ticona LLC, Florence, KY (US)

(72) Inventors: Zhe Tan, Shanghai (CN); Cheng Wan, Shanghai (CN); Jinhui Huang, Shanghai (CN); Fangfang Tao, Shanghai (CN)

(21) Appl. No.: 18/425,296

(22) Filed: Jan. 29, 2024

Related U.S. Application Data
(60) Provisional application No. 63/484,216, filed on Feb. 10, 2023.

(51) Int. Cl. H01M 50/193; H01M 50/198

(52) U.S. Cl. CPC H01M 50/193; H01M 50/198

(57) ABSTRACT

A nonaqueous electrochemical battery is provided. The battery comprises a housing containing an interior space extending to an open end, as well as positive electrode, negative electrode, separator, and electrolyte disposed within the interior space of the housing. A sealing member is disposed adjacent to the open end of the housing, wherein the sealing member comprises a polymer composition that contains a polyarylene sulfide and a bifunctional polymer that contains an epoxide functional group and a (meth)acrylate functional group. The polymer composition has an epoxy content of from about 0.3 to about 2 parts by weight per 100 parts by weight of polyarylene sulfides in the polymer composition.

### RELATED APPLICATION

The present application is based upon and claims priority to U.S. Provisional Patent Application Ser. No. 63/486,216, having a filing date of Feb. 10, 2023, which is incorporated herein by reference.

### BACKGROUND OF THE INVENTION

Electric vehicles, such as battery-electric vehicles, plug-in hybrid-electric vehicles, mild hybrid-electric vehicles, or full hybrid-electric vehicles generally have an electric powertrain that contains a pack of nonaqueous electrochemical batteries (e.g., lithium ion batteries), which each include an anode, cathode, separator, and electrolyte sealed within a housing structure. Because the cathode and electrolyte materials are so reactive, the batteries often contain glass seals to seal the metal components that must be electrically insulated and to seal small apertures in the housings. Due to the high cost of the glass seals, attempts have also been made to use thermoplastic polymer sealing systems. For example, a thermoplastic gasket can be compressed between the inside top edge of the housing (e.g., a steel can) and the periphery of the cover closing the open top of the can, forming a seal to keep the electrolyte within the cell housing and to keep water out. A thermoplastic cover can also be used to seal an aperture in the cell housing. Despite having certain benefits, the polymer materials used in such sealing systems often exhibit poor adhesion to the housing and/or other metal components of the battery, which adversely impacts performance, particularly at high temperatures. As such, a need currently exists for an improved sealing system for a nonaqueous electrochemical battery.

### SUMMARY OF THE INVENTION

In accordance with one embodiment of the present invention, a nonaqueous electrochemical battery is disclosed that comprises a housing containing an interior space extending to an open end, and a positive electrode, negative electrode, separator, and electrolyte disposed within the interior space of the housing. A sealing member is disposed adjacent to the open end of the housing. The sealing member comprises a polymer composition that contains a polyarylene sulfide and a bifunctional polymer that contains an epoxide functional group and a (meth)acrylate functional group. The polymer composition has an epoxy content of from about 0.3 to about 2 parts by weight per 100 parts by weight of polyarylene sulfides in the polymer composition.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 illustrates one embodiment of the nonaqueous electrochemical battery of the present invention;

FIG. 2 illustrates another embodiment of the nonaqueous electrochemical battery of the present invention; and

FIG. 3 illustrates an electric vehicle including components that may incorporate the composite structure of the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a nonaqueous electrochemical battery (e.g., lithium ion battery) that includes a housing containing an interior space extending to an open end, as well as positive electrode, negative electrode, separator, and electrolyte disposed within the interior space of the housing. A sealing member is also disposed adjacent to the open end of the housing. Notably, the sealing member contains a polymer composition that includes a polyarylene sulfide. By selectively controlling the particular nature of the components of the polymer composition, as well as their relative concentration, the present inventors have discovered that the resulting polymer composition can achieve a unique combination of properties that facilitates its use in the sealing member of a nonaqueous electrochemical battery. For example, the polymer composition may include at least one bifunctional polymer that contains both epoxide and (meth)acrylate functional groups. Without intending to be limited by theory, it is believed that such polymers can help improve adhesion to other components of the electrochemical battery to help minimize leakage of the electrode from the housing. If desired, the polymer composition may also be generally free of certain additives that might interfere with adhesion of the sealing member to other components of the cell, such as inorganic fibers (e.g., glass fibers) and/or inorganic particulate fillers (e.g., talc, mica, etc.).

In addition to helping to improve adhesion to other cell components, the polymer composition may have also exhibit other beneficial properties that can help minimize electrolyte leakage. For example, the composition may still exhibit good flow properties as reflected by a relatively low melt viscosity, such as about 30 kP or less, in some embodiments about 20 kP or less, in some embodiments about 10 kP or less, in some embodiments about 5 kP or less, and in some embodiments, from about 0.5 to about 4 kP, as determined in accordance with ISO 11443:2021 at a temperature of about 310° C. and at a shear rate of 1,000 s⁻¹. The polymer composition may also retain a high degree of heat resistance, which may be characterized by its deflection temperature under load (“DTUL”). More particularly, the polymer composition may exhibit a DTUL value of from about 70° C. to about 220° C., in some embodiments from about 80° C. to about 200° C., and in some embodiments, from about 90° C. to about 150° C. as determined in accordance with ISO 75-2:2013 at a load of 1.8 MPa.

Despite having a low melt viscosity, the polymer composition may nevertheless maintain a high degree of impact strength as well as tensile strength, which can provide enhanced flexibility for the resulting structure. For example, the polymer composition may exhibit a Charpy notched impact strength of about 6 kJ/m² or more, such as in some embodiments from about 10 to about 50 kJ/m², and in some embodiments, from about 15 to about 30 kJ/m², as determined at a temperature of 23° C. in accordance with ISO 179-1:2010. The composition may also exhibit a tensile stress at break of about 50 MPa or more, in some embodiments from about 40 MPa to about 250 MPa, and in some embodiments, from about 60 to about 200 MPa; a tensile break strain of about 1% or more, in some embodiments from about 1.2% to about 5%; and/or a tensile modulus of about 8,000 MPa or more, in some embodiments from about 9,000 MPa to about 20,000 MPa, in some embodiments from about 10,000 MPa to about 18,000 MPa. The tensile properties may be determined in accordance with ISO 527:2019 at a temperature of 23° C. The composition may also exhibit a flexural strength of about 50 MPa or more, in some embodiments from about 60 to about 350 MPa, and in some embodiments from about 80 to about 300 MPa, and/or a flexural modulus of from about 1,000 to about 20,000, in some embodiments from about 1,500 MPa to about 15,000 MPa, and in some embodiments, from about 2,000 MPa to about 10,000 MPa. The flexural properties may be determined in accordance with ISO 178:2019 at a temperature of 23° C.

Various embodiments of the present invention will now be described in greater detail below.

### I. Polymer Composition

### A. Polyarylene Sulfide

The polymer composition generally contains one or more polyarylene sulfides, typically in an amount of from about 60 wt. % to about 99 wt. %, in some embodiments from about 70 wt. % to about 96 wt. %, in some embodiments from about 75 wt. % to about 95 wt. %, and in some embodiments, from about 80 wt. % to about 94 wt. % of the entire polymer composition. The polyarylene sulfide may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

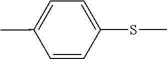

and segments having the structure of formula:

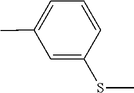

or segments having the structure of formula:

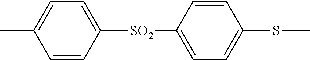

The polyarylene sulfide may be linear, semi-linear, branched, or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

If desired, the polyarylene sulfide can be functionalized. For instance, a disulfide compound containing reactive functional groups (e.g., carboxyl, hydroxyl, amine, etc.) can be reacted with the polyarylene sulfide. Functionalization of the polyarylene sulfide can further provide sites for bonding between any bifunctional polymers and the polyarylene sulfide, which can improve distribution of the bifunctional polymer throughout the polyarylene sulfide and prevent phase separation. The disulfide compound may undergo a chain scission reaction with the polyarylene sulfide during melt processing to lower its overall melt viscosity. When employed, disulfide compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula:

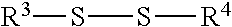

wherein R³ and R⁴ may be the same or different and are hydrocarbon groups that independently include from 1 to about 20 carbons. For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at termination end(s) of the disulfide compound. For example, at least one of R³ and R⁴ may include a termination carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid (or 2,2′-dithiobenzoic acid), dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole), 2-(4′-morpholinodithio)benzothiazole, etc., as well as mixtures thereof.

The melt flow rate of a polyarylene sulfide may be from about 100 to about 800 grams per 10 minutes (“g/10 min”), in some embodiments from about 200 to about 700 g/10 min, and in some embodiments, from about 300 to about 600 g/10 min, as determined in accordance with ISO 1133 at a load of 5 kg and temperature of 316° C.

The polyarylene sulfides, such as described above, typically have a DTUL value of from about 70° C. to about 220° C., in some embodiments from about 90° C. to about 200° C., and in some embodiments, from about 120° C. to about 180° C. as determined in accordance with ISO 75-2:2013 at a load of 1.8 MPa. The polyarylene sulfides likewise typically have a glass transition temperature of from about 50° C. to about 120° C., in some embodiments from about 60° C. to about 115° C., and in some embodiments, from about 70° C. to about 110° C., as well as a melting temperature of from about 220° C. to about 340° C., in some embodiments from about 240° C. to about 320° C., and in some embodiments, from about 260° C. to about 300° C.

### B. Bifunctional Polymer

As indicated above, a bifunctional polymer may also be employed within the polymer composition. Typically, the bifunctional polymer(s) constitute from about 1 to about 20 parts, in some embodiments from about 2 to about 16 parts, in some embodiments from about 3 to about 15 parts, and in some embodiments, from about 4 to about 12 parts by weight per 100 parts by weight of the polyarylene sulfide(s). For example, the bifunctional polymers may constitute from about 1 wt. % to about 20 wt. %, in some embodiments from about 3 wt. % to about 15 wt. %, and in some embodiments, from about 4 wt. % to about 12 wt. % of the polymer composition. As noted above, the polymer is generally considered “bifunctional” in the sense that it that contains both epoxide and (meth)acrylate functional groups. As used herein, the term “(meth)acrylate” generally includes acrylic and methacrylic groups, as well as salts or esters thereof, such as acrylate and methacrylate groups. The epoxide and (meth)acrylate functional groups may be provide on the same monomeric unit of the polymer and/or on different monomeric units. In one embodiment, for example, the functional groups may be provided within the same monomeric unit. In such embodiments, for example, the bifunctional polymer may contain a monomeric unit that is derived from an epoxy-functional (meth)acrylate, such as, but not limited to, those containing 1,2-epoxy groups, such as glycidyl acrylate and glycidyl methacrylate. Other suitable epoxy-functional (meth)acrylates include glycidyl ethacrylate and glycidyl itoconate.

Of course, other suitable monomers may also be employed to help achieve the desired molecular weight. In one embodiment, for instance, the bifunctional polymer may also contain an olefinic monomeric unit that is derived from an α-olefin. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefins are ethylene and propylene. In one embodiment, for example, the bifunctional polymer may be a copolymer of an α-olefin (e.g., ethylene) and glycidyl (meth)acrylate. Another suitable monomeric unit that may optionally be employed may include one derived from a (meth)acrylate that is not epoxy-functional. Examples of such (meth)acrylates may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one embodiment, for example, the bifunctional polymer may be a copolymer of an α-olefin (e.g., ethylene), glycidyl (meth)acrylate, and a non-epoxy functional (meth)acrylate (e.g., butyl acrylate, methyl acrylate, etc.).

The epoxy content of the overall composition may be selectively controlled to help achieve the desired melt flow viscosity, ductility, and impact strength. Too low of an epoxy content, for example, may lead to poor interaction with the polyarylene sulfide and thus limit the impact strength of the resulting polymer composition. On the other hand, too high of an epoxy content may impact the overall ductility of the composition. Thus, it is typically desired that the epoxy content of the composition is from about 0.3 to about 2 parts by weight, in some embodiments from about 0.35 to about 1.6 parts by weight, in some embodiments, from about 0.4 to about 1.4 parts, and in some embodiments, from about 0.5 to about 1 part by weight per 100 parts by weight of the polyarylene sulfides employed in the polymer composition. In certain embodiments, for example, epoxy-functional (meth)acrylate monomer(s) (e.g. glycidyl methacrylate(s)) may constitute from about 1 wt. % to about 20 wt. %, in some embodiments from about 2 wt. % to about 15 wt. %, and in some embodiments, from about 3 wt. % to about 10 wt. % of the polymer. When employed, α-olefin monomer(s) may likewise constitute from about 55 wt. % to about 95 wt. %, in some embodiments from about 60 wt. % to about 90 wt. %, and in some embodiments, from about 65 wt. % to about 85 wt. % of the polymer, and non-epoxy functional (meth)acrylate monomers may constitute from about 5 wt. % to about 35 wt. %, in some embodiments from about 8 wt. % to about 30 wt. %, and in some embodiments, from about 10 wt. % to about 25 wt. % of the copolymer.

The melt flow index of the bifunctional polymer may also be selectively controlled to help achieved the desired properties. For instance, the melt flow index of the bifunctional polymer may be from about 1 to about 30 grams per 10 minutes (“g/10 min”), in some embodiments from about 2 to about 20 g/10 min, and in some embodiments, from about 4 to about 15 g/10 min, as determined in accordance with ASTM D1238-20 at a load of 2.16 kg and temperature of 190° C. Particular examples of suitable bifunctional polymers that may be employed are commercially available from SK under the name LOTADER® AX8840 or AX8900. LOTADER® AX8840, for instance, is a random copolymer of ethylene and glycidyl methacrylate (8 wt. %), and has a melt flow melt index of 5 g/10 min at 190° C. LOTADER® AX8900 is a random copolymer of ethylene, methyl acrylate (24 wt. %), and glycidyl methacrylate (8 wt. %), and has a melt flow melt index of 6 g/10 min at 190° C. Another suitable copolymer is commercially available from Dow under the name ELVALOY® PTW, which is a terpolymer of ethylene, butyl acrylate, and glycidyl methacrylate (5 wt. %), and has a melt flow index of 12 g/10 min.

### C. Epoxy Resin

While optional, the polymer composition may also contains an epoxy resin. The epoxy resin can be selected to have a certain controlled epoxy equivalent weight, which can allow it to undergo a crosslinking reaction with the bifunctional polymer, thus improving compatibility of the components and increasing the mechanical properties of the resulting composition. The epoxy groups of the resin are also believed to further enhance the adhesion of the composition to metal components. When employed, the epoxy resin(s) typically constitute from about 0.1 to about 10 parts, in some embodiments from about 0.2 to about 5 parts, and in some embodiments, from about 0.3 to about 1 part by weight per 100 parts by weight of the polyarylene sulfide(s). For example, epoxy resins may constitute from about 0.1 wt. % to about 10 wt. %, in some embodiments from about 0.2 wt. % to about 5 wt. %, and in some embodiments, from about 0.3 wt. % to about 1 wt. % of the polymer composition.

Epoxy resins having a certain epoxy equivalent weight are particularly effective for use in the polymer composition. Namely, the epoxy equivalent weight may generally be from about 250 to about 1,500, in some embodiments from about 400 to about 1,000, and in some embodiments, from about 500 to about 800 grams per gram equivalent as determined in accordance with ASTM D1652-11(2019). The epoxy resin also typically contains, on the average, at least about 1.3, in some embodiments from about 1.6 to about 8, and in some embodiments, from about 2 to about 5 epoxide groups per molecule. The epoxy content of the resin may thus typically range from about 20 wt. % to about 80 wt. %, in some embodiments from about 40 wt. % to about 75 wt. %, and in some embodiments, from about 50 wt. % to about 70 wt. % of the resin. The epoxy resin may have a relatively low dynamic viscosity, such as from about 1 centipoise to about 25 centipoise, in some embodiments 2 centipoise to about 20 centipoise, and in some embodiments, from about 5 centipoise to about 15 centipoise, as determined in accordance with ASTM D445-21 at a temperature of 25° C. At room temperature (25° C.), the epoxy resin is also typically a solid or semi-solid material having a melting point of from about 50° C. to about 120° C., in some embodiments from about 60° C. to about 110° C., and in some embodiments, from about 70° C. to about 100° C.

The epoxy resin can be saturated or unsaturated, linear or branched, aliphatic, cycloaliphatic, aromatic or heterocyclic, and may bear substituents which do not materially interfere with the reaction with the oxirane. Suitable epoxy resins include, for instance, glycidyl ethers (e.g., diglycidyl ether) that are prepared by reacting an epichlorohydrin with a hydroxyl compound containing at least 1.5 aromatic hydroxyl groups, optionally under alkaline reaction conditions. Dihydroxyl compounds are particularly suitable. For instance, the epoxy resin may be a diglycidyl ether of a dihydric phenol, diglycidyl ether of a hydrogenated dihydric phenol, etc. Diglycidyl ethers of dihydric phenols may be formed, for example, by reacting an epihalohydrin with a dihydric phenol. Examples of suitable dihydric phenols include, for instance, 2,2-bis(4-hydroxyphenyl) propane (“bisphenol A”); 2,2-bis 4-hydroxy-3-tert-butylphenyl) propane; 1,1-bis(4-hydroxyphenyl) ethane; 1,1-bis(4-hydroxyphenyl) isobutane; bis(2-hydroxy-1-naphthyl) methane; 1,5 dihydroxynaphthalene; 1,1-bis(4-hydroxy-3-alkylphenyl) ethane, etc. Suitable dihydric phenols can also be obtained from the reaction of phenol with aldehydes, such as formaldehyde) (“bisphenol F”). Commercially available examples of such epoxy resins may include EPON™ Resins available from Hexion, Inc. under the designations 862, 828, 826, 825, 1001, 1002, SU3, 154, 1031, 1050, 133, and 165.

### D. Optional Components

In addition to the components noted above, the polymer composition may also contain a variety of other optional components to help improve its overall properties. As indicated above, the polymer composition may also be generally free of certain additives, such as inorganic fibers and/or inorganic particulate fillers. Examples of inorganic particulate fillers may include, for instance, clay minerals, such as talc (Mg₃Si₄O₁₀(OH)₂), halloysite (Al₂Si₂O₅(OH)₄), kaolinite (Al₂Si₂O₅(OH)₄), illite ((K,H₃O)(Al,Mg,Fe)₂ (Si,Al)₄O₁₀[(OH)₂,(H₂O)]), montmorillonite (Na,Ca)_{0.33}(Al,Mg)₂Si₄O₁₀(OH)₂·nH₂O), vermiculite ((MgFe,Al)₃(Al,Si)₄O₁₀(OH)₂·4H₂O), palygorskite ((Mg,Al)₂Si₄O₁₀(OH)·4(H₂O)), and pyrophyllite (Al₂Si₄O₁₀(OH)₂); carbonate fillers (e.g., calcium carbonate); silicate fillers (e.g., calcium silicate, aluminum silicate, mica, diatomaceous earth, and wollastonite); and sulfate fillers (e.g., barium sulfate and calcium sulfate). Examples of inorganic fibers may include, for instance, glass fibers. By “generally free”, it is contemplated that such additives are completely absent from the composition or, at the very least, present in only trace amounts. For example, such release additives are generally present in an amount of about 1,000 parts per million (“ppm’) or less, in some embodiments about 500 ppm or less, in some embodiments about 100 ppm or less, and in some embodiments, about 50 ppm or less (e.g., 0 ppm).

If desired, a crosslinking system may also be employed in combination with the bifunctional polymer to help further improve the strength and flexibility of the composition under a variety of different conditions. When employed, such a crosslinking system, which may contain one or more crosslinking agents, typically constitutes from about 0.01 to about 5 parts, in some embodiments from about 0.02 to about 3 parts, and in some embodiments, from about 0.05 to about 1 part per 100 parts of the polyarylene sulfide(s), as well as from about 0.01 wt. % to about 5 wt. %, in some embodiments from about 0.02 wt. % to about 3 wt. %, and in some embodiments, from about 0.05 wt. % to about 1 wt. % of the polymer composition. Through the use of such a crosslinking system, the compatibility and distribution of the polyarylene sulfide and impact modifier can be significantly improved. For example, the impact modifier is capable of being dispersed within the polymer composition in the form of discrete domains of a nano-scale size. For example, the domains may have an average cross-sectional dimension of from about 1 to about 1000 nanometers, in some embodiments from about 5 to about 800 nanometers, in some embodiments from about 10 to about 500 nanometers. The domains may have a variety of different shapes, such as elliptical, spherical, cylindrical, plate-like, tubular, etc. Such improved dispersion can result in either better mechanical properties or allow for equivalent mechanical properties to be achieved at lower amounts of impact modifier.

Any of a variety of different crosslinking agents may generally be employed within the crosslinking system. In one embodiment, for instance, the crosslinking system may include a metal carboxylate. Without intending to be limited by theory, it is believed that the metal atom in the carboxylate can act as a Lewis acid that accepts electrons from the oxygen atom located in a functional group (e.g., epoxy functional group) of the bifunctional polymer. Once it reacts with the carboxylate, the functional group can become activated and can be readily attacked at either carbon atom in the three-membered ring via nucleophilic substitution, thereby resulting in crosslinking between the chains of the bifunctional polymer. The metal carboxylate is typically a metal salt of a fatty acid. The metal cation employed in the salt may vary, but is typically a divalent metal, such as calcium, magnesium, lead, barium, strontium, zinc, iron, cadmium, nickel, copper, tin, etc., as well as mixtures thereof. Zinc is particularly suitable. The fatty acid may generally be any saturated or unsaturated acid having a carbon chain length of from about 8 to 22 carbon atoms, and in some embodiments, from about 10 to about 18 carbon atoms. If desired, the acid may be substituted. Suitable fatty acids may include, for instance, lauric acid, myristic acid, behenic acid, oleic acid, palmitic acid, stearic acid, ricinoleic acid, capric acid, neodecanoic acid, hydrogenated tallow fatty acid, hydroxy stearic acid, the fatty acids of hydrogenated castor oil, erucic acid, coconut oil fatty acid, etc., as well as mixtures thereof. Metal carboxylates typically constitute from about 0.05 wt. % to about 5 wt. %, in some embodiments from about 0.1 wt. % to about 2 wt. %, and in some embodiments, from about 0.2 wt. % to about 1 wt. % of the polymer composition.

The crosslinking system may also employ a crosslinking agent that is “multi-functional” to the extent that it contains at least two reactive, functional groups. Such a multi-functional crosslinking reagent may serve as a weak nucleophile, which can react with activated functional groups on the impact modifier (e.g., epoxy functional groups). The multi-functional nature of such molecules enables them to bridge two functional groups on the bifunctional polymer, effectively serving as a curing agent. The multi-functional crosslinking agents generally include two or more reactively functional terminal moieties linked by a bond or a non-polymeric (non-repeating) linking component. By way of example, the crosslinking agent can include a di-epoxide, poly-functional epoxide, diisocyanate, polyisocyanate, polyhydric alcohol, water-soluble carbodiimide, diamine, diol, diaminoalkane, multi-functional carboxylic acid, diacid halide, etc. Multi-functional carboxylic acids and amines are particularly suitable. Specific examples of multi-functional carboxylic acid crosslinking agents can include, without limitation, isophthalic acid, terephthalic acid, phthalic acid, 1,2-di(p-carboxyphenyl)ethane, 4,4′-dicarboxydiphenyl ether, 4,4′-bisbenzoic acid, 1,4- or 1,5-naphthalene dicarboxylic acids, decahydronaphthalene dicarboxylic acids, norbornene dicarboxylic acids, bicyclooctane dicarboxylic acids, 1,4-cyclohexanedicarboxylic acid (both cis and trans), 1,4-hexylenedicarboxylic acid, adipic acid, azelaic acid, dicarboxyl dodecanoic acid, succinic acid, maleic acid, glutaric acid, suberic acid, azelaic acid and sebacic acid. The corresponding dicarboxylic acid derivatives, such as carboxylic acid diesters having from 1 to 4 carbon atoms in the alcohol radical, carboxylic acid anhydrides or carboxylic acid halides may also be utilized. In certain embodiments, aromatic dicarboxylic acids are particularly suitable, such as isophthalic acid or terephthalic acid.

Still other components that can be included in the composition may include, for instance, lubricants, antimicrobials, pigments (e.g., black pigments), antioxidants, stabilizers, surfactants, flow promoters, solid solvents, and other materials added to enhance properties and processability.

### II. Melt Processing

The manner in which the polyarylene sulfide(s), bifunctional polymer, and various other optional additives are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 100° C. to about 500° C., and in some embodiments, from about 150° C. to about 300° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance, the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally, it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

The crystallization temperature of the resulting polymer composition (prior to being formed into a shaped part) may be about 250° C. or less, in some embodiments from about 100° C. to about 245° C., and in some embodiments, from about 150° C. to about 240° C. The melting temperature of the polymer composition may also range from 140° C. to about 380° C., in some embodiments from about 200° C. to about 360° C., in some embodiments from about 250° C. to about 320° C., and in some embodiments, from about 260° C. to about 300° C. The melting and crystallization temperatures may be determined as is well known in the art using differential scanning calorimetry in accordance with ISO 11357-3:2018.

### III. Sealing Member

As indicated above, the unique properties of the polymer composition can more readily allow it to be formed into a sealing member for use in a nonaqueous electrochemical battery. The particular nature of the sealing member may vary as is known in art, and may, for example, be in the shape of a ring, gasket, plate, cover, etc. Regardless, the polymer composition may be shaped into the desired form for the sealing member using a variety of techniques, such as by molding, film formation, extrusion, etc. In one embodiment, for example, the polymer composition may be molded into the desired shape for the sealing member. Suitable molding techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity.

### IV. Nonaqueous Electrochemical Battery

The sealing member may be employed in a wide variety of nonaqueous electrochemical battery configurations (e.g., lithium ion batteries) as is known in the art. Such batteries generally contain an electrode assembly containing a positive and negative electrode contained within an interior space of a housing. The positive electrode may include a positive electrode material. Suitable positive electrode active materials may include, for instance, metal oxides, such as manganese dioxide, vanadium oxide, niobium oxide, titanium oxide, etc.; sulfides, such as iron disulfide; fluorides, such as graphite fluoride; lithium-containing metal oxides, such as LiₓMn₃O₆ (0<x<2), LiₓMnO₂ (0<x<1), LiₓTi_{5/3}O₄ (4/3≤x<7/3), LiMn₂O₄, LiMn_{1/3}Ni_{1/3}Co_{1/3}O₂, LiMn_{5/12}Ni_{5/12}CO_{1/6}O₂, LiNi_{3/5}Mn_{1/5}Co_{1/5}O₂, etc.); and so forth, as well as combinations thereof. Substituted spinel-structured composite oxides containing lithium in a layered structure may also be employed, such as those represented by Li₁₊ₓM¹O₂ (−0.1<x<0.1, M¹ is a metal, such as Co, Ni, Mn, Al, Mg, etc.). Examples thereof include lithium-containing composite oxides such as olivine-type compounds represented by LiM²PO₄ (M² is a metal, such as Co, Ni, Mn, Fe, etc.). The negative electrode may likewise include a negative electrode active material. Examples of such material may include, for instance, lithium or lithium alloys (e.g., lithium-aluminum alloy); carbonaceous materials, such as graphite, activated carbon, carbon fibers, glass carbon, mesocarbon microbeads; etc., as well as combinations thereof. If desired, a conductivity promoter may also be employed in the positive electrode and/or negative active materials to further increase electrical conductivity. Exemplary conductivity promoters may include, for instance, carbon black, graphite (natural or artificial), graphite, carbon nanotubes, nanowires or nanotubes, metal fibers, graphenes, etc., as well as mixtures thereof. Binders may also be employed in positive and/or negative active electrode materials, such as polyvinylidene fluoride (PVDF), polytetrafluoroethylene (PTFE), styrene butadiene rubber (SBR), carboxymethyl cellulose (CMC), polyvinylpyrrolidone (PVP), etc.

The positive and/or electrode active materials may be disposed on a current collector. The current collector is typically formed from a substrate that includes a conductive metal, such as aluminum, stainless steel, nickel, silver, palladium, etc., as well as alloys thereof. Aluminum and aluminum alloys are particularly suitable. The substrate may be in the form of a foil, sheet, plate, mesh, etc. The substrate may also have a relatively small thickness, such as about 200 micrometers or less, in some embodiments from about 1 to about 100 micrometers, in some embodiments from about 5 to about 80 micrometers, and in some embodiments, from about 10 to about 50 micrometers. Although by no means required, the surface of the substrate may be optionally roughened, such as by washing, etching, blasting, etc.

The electrode assembly also typically contains a separator that is positioned between the positive and negative electrode. If desired, other separators may also be employed in the electrode assembly. The separator enables electrical isolation of one electrode from another to help prevent an electrical short, but still allow transport of ions between the two electrodes. In certain embodiments, for example, a separator may be employed that includes a cellulosic fibrous material (e.g., airlaid paper web, wet-laid paper web, etc.), nonwoven fibrous material (e.g., polyolefin nonwoven webs), woven fabrics, microporous films, etc. Particularly suitable are microporous films containing a polyolefin, such as polypropylene, polyethylene (e.g., ultrahigh molecular weight polyethylene), etc. Regardless of the particular materials employed, the separator typically has a thickness of from about 5 to about 150 micrometers, in some embodiments from about 10 to about 100 micrometers, and in some embodiments, from about 20 to about 80 micrometers. Regardless, the manner in which the components of the electrode assembly are combined together may vary. For example, the electrodes and separator may be initially folded, wound, or otherwise contacted together to form an electrode assembly. In one particular embodiment, the electrodes and separator may be wound into an electrode assembly having a “jelly-roll” configuration.

An electrolyte is also placed into ionic contact with the electrodes before, during, and/or after the electrodes and separator are combined together to form the electrode assembly. The electrolyte generally contains a salt dissolved in an organic solvent. When forming a lithium ion battery, for instance, the salt may be a lithium salt, such as LiClO₄, LiPF₆, LiBF₄, LiAsF₆, LiSbF₆, LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃ (n≥2), LiN(R_{f}OSO₂)₂ [where R_{f} is a fluoroalkyl group], and so forth, as well as combinations thereof. Other suitable salts may include ionic liquid salts, such as spiro-(1,1′)-bipyrrolidinium tetrafluoroborate, triethylmethyl ammonium tetrafluoroborate, tetraethyl ammonium tetrafluoroborate, spiro-(1,1′)-bipyrrolidinium iodide, triethylmethyl ammonium iodide, tetraethyl ammonium iodide, methyltriethylammonium tetrafluoroborate, tetrabutylammonium tetrafluoroborate, tetraethylammonium hexafluorophosphate, etc. While the concentration of the salt can vary, it is typically present in an amount of about 0.5 moles per liter (M) of the electrolyte or more, in some from about 0.5 to about 1.5, and in some embodiments, from about 0.8 to about 1.4 M. The electrolyte is generally nonaqueous in nature and thus contains at least one nonaqueous solvent. Particularly suitable solvents may include, for instance, cyclic carbonate solvents, such as ethylene carbonate, propylene carbonate, butylene carbonate, vinylene carbonate, etc. Of course, other nonaqueous solvents may also be employed, either alone or in combination with a cyclic carbonate solvent. Examples of such solvents may include, for instance, open-chain carbonates (e.g., dimethyl carbonate, ethyl methyl carbonate, diethyl carbonate, etc.), aliphatic monocarboxylates (e.g., methyl acetate, methyl propionate, etc.), lactone solvents (e.g., butyrolactone valerolactone, etc.), nitriles (e.g., acetonitrile, glutaronitrile, adiponitrile, methoxyacetonitrile, 3-methoxypropionitrile, etc.), amides (e.g., N,N-dimethylformamide, N,N-diethylacetamide, N-methylpyrrolidinone), alkanes (e.g., nitromethane, nitroethane, etc.), sulfur compounds (e.g., sulfolane, dimethyl sulfoxide, etc.); and so forth.

As noted above, the battery also contains a housing having an interior space within which the electrode assembly and electrolyte are retained. The nature of the housing may vary as desired. In one embodiment, for example, the housing may contain a metal container (“can”), such as those formed from tantalum, niobium, aluminum, nickel, hafnium, titanium, copper, silver, steel (e.g., stainless), alloys thereof, composites thereof (e.g., metal coated with electrically conductive oxide), and so forth. Aluminum or stainless steel are particularly suitable. The housing may have any of a variety of different shapes, such as cylindrical, button shaped, coin-shaped, prismatic, D-shaped, etc. Regardless, the housing generally contains an open end over which the sealing member described above can be disposed.

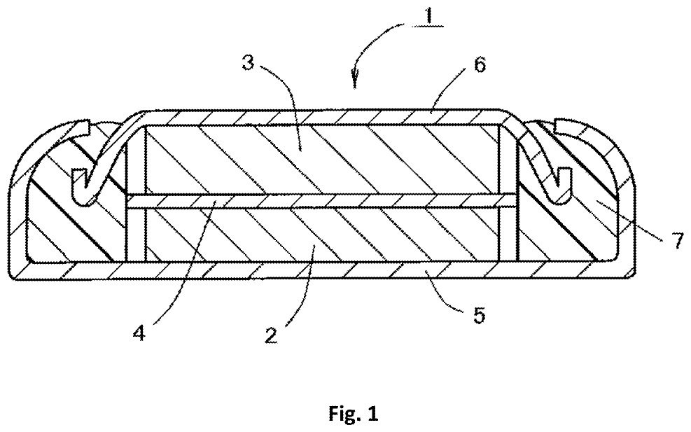

Referring to FIG. 1, for example, one embodiment a battery 1 is shown that contains a housing 5 that contains an interior space within which a positive electrode 2, separator 4, negative electrode 3, and electrolyte (not shown) are disposed. A cover 6, which may be formed as a sealing member as described herein, is also disposed over an opening of the housing 5. A gasket 7 may also be inserted into the interior space of the housing 5 so that it is positioned between the housing and the cover 6. If desired, the gasket 7 may be formed as a sealing member as described herein. In the illustrated embodiment, the open end of the housing 5 is bent inwardly so that the gasket 7 comes into contact with the cover 6, and so that the opening of the housing 5 is sealed.

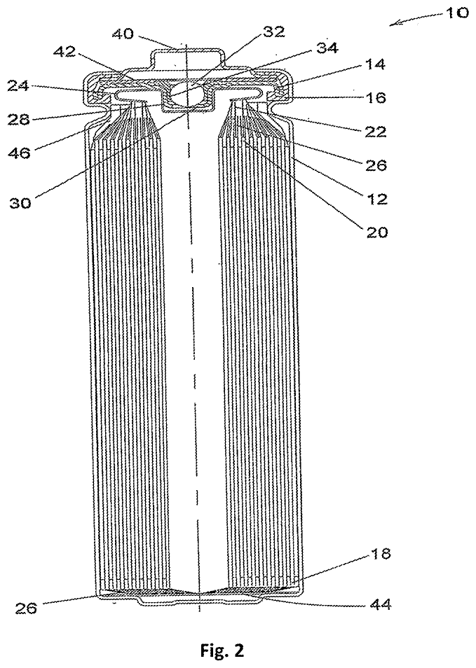

In the embodiment shown in FIG. 1, the battery 1 is generally in the shape of coin or button. Of course, other configurations may also be employed as is known in the art. Referring to FIG. 2, for instance, a cylindrically-shaped battery 10 is shown that includes a housing 12 with a closed bottom and an open top end that is closed with a battery cover 14 and a gasket 16. The battery cover 14 and/or gasket 16 may be formed as a sealing member as described herein. In the illustrated embodiment, the housing 12 has a bead or reduced diameter step near the top end to support the gasket 16 and the cover 14. The gasket 16 is compressed between the housing 12 and the cover 14 to seal a negative electrode 18, a positive electrode 20 and electrolyte (not shown) within the battery 10. The negative electrode 18, positive electrode 20 and a separator 26 are spirally wound together into an electrode assembly. The positive electrode 20 may contain a current collector 22, which extends from the top end of the electrode assembly and is connected to the inner surface of the cover 14 with a contact spring 24. The negative electrode 18 may likewise be electrically connected to the inner surface of the housing 12 by a metal tab (not shown). An insulating cone 46 may be located around the peripheral portion of the top of the electrode assembly to prevent the cathode current collector 22 from making contact with the housing 12, and contact between the bottom edge of the positive electrode 20 and the bottom of the housing 12 is prevented by the inward-folded extension of the separator 26 and an electrically insulating bottom disc 44 positioned in the bottom of the housing 12. The battery 10 may also have a separate positive terminal cover 40, which is held in place by the inwardly crimped top edge of the housing 12 and the gasket 16. The cover 40 may also be formed as a sealing member as described herein. If desired, a positive temperature coefficient device 42 may be disposed between the peripheral flange of the terminal cover 40 and the battery cover 14 is to help limit the flow of current under certain conditions. The battery 10 may also include a pressure relief vent. For example, the battery cover 14 may have an aperture comprising an inward projecting central vent well 28 with a vent hole 30 in the bottom of the well 28. The aperture is sealed by a vent ball 32 and a bushing 34, which is compressed between the vertical wall of the vent well 28 and the periphery of the vent ball 32. When the internal pressure exceeds a predetermined level, the vent ball 32, or both the ball 32 and bushing 34, are forced out of the aperture to release pressurized gases from the battery 10.

### V. Electrical Vehicle

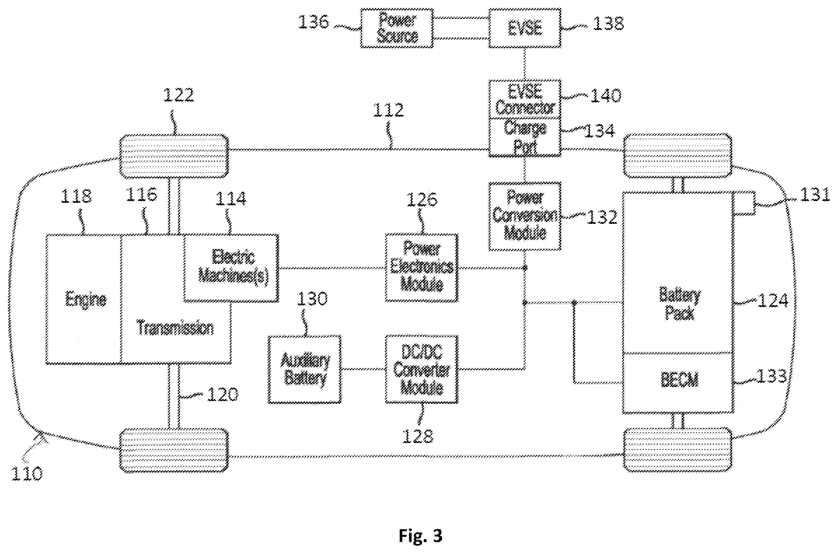

While the battery above may be employed in a wide variety of applications, the present inventors have discovered that such components are particularly suitable for use in a powertrain of an electric vehicle, such as a battery-powered electric vehicle, plug-in hybrid-electric vehicle (PHEV), mild hybrid-electric vehicle (MHEV), full hybrid-electric vehicle (FHEV), etc. Referring to FIG. 3, for instance, one embodiment of an electric vehicle 112 that includes a powertrain 110 is shown. The powertrain 110 contains one or more electric machines 114 connected to a transmission 116, which in turn is mechanically connected to a drive shaft 120 and drive wheels 122. Although by no means required, the transmission 116 in this particular embodiment is also connected to an engine 118, though the description herein is equally applicable to a pure electric vehicle. The electric machines 114 may be capable of operating as a motor or a generator to provide propulsion and deceleration capability. The powertrain 110 also includes a propulsion source, such as a battery assembly 124, which stores and provides energy for use by the electric machines 114. The battery assembly 124 typically provides a high voltage current output (e.g., DC current at a voltage of from about 400 volts to about 800 volts) from one or more battery arrays that may include one or more batteries.

The powertrain 110 may also contain at least one power electronics module 126 that is connected to the battery assembly 124 (also commonly referred to as a battery pack) containing one or more batteries of the present invention. The power electronics module 126 may also contain a power converter (e.g., converter, inverter, etc., as well as combinations thereof). The power electronics module 126 is typically electrically connected to the electric machines 114 and provides the ability to bi-directionally transfer electrical energy between the battery assembly 124 and the electric machines 114. For example, the battery assembly 124 may provide a DC voltage while the electric machines 114 may require a three-phase AC voltage to function. The power electronics module 126 may convert the DC voltage to a three-phase AC voltage as required by the electric machines 114. In a regenerative mode, the power electronics module 126 may convert the three-phase AC voltage from the electric machines 114 acting as generators to the DC voltage required by the battery assembly 124. The battery assembly 124 may also provide energy for other vehicle electrical systems. For example, the powertrain may employ a DC/DC converter module 128 that converts the high voltage DC output from the battery assembly 124 to a low voltage DC supply that is compatible with other vehicle loads, such as compressors and electric heaters. In a typical vehicle, the low-voltage systems are electrically connected to an auxiliary battery 130 (e.g., 12V battery). A battery energy control module (BECM) 133 may also be present that is in communication with the battery assembly 124 that acts as a controller for the battery assembly 124 and may include an electronic monitoring system that manages temperature and charge state of each of the batteries. The battery assembly 124 may also have a temperature sensor 131, such as a thermistor or other temperature gauge. The temperature sensor 131 may be in communication with the BECM 133 to provide temperature data regarding the battery assembly 124. The temperature sensor 131 may also be located on or near the batteries within the traction battery 124. It is also contemplated that more than one temperature sensor 131 may be used to monitor temperature of the batteries. In certain embodiments, the battery assembly 124 may be recharged by an external power source 136, such as an electrical outlet. The external power source 136 may be electrically connected to electric vehicle supply equipment (EVSE) that regulates and manages the transfer of electrical energy between the power source 36 and the vehicle 112. The EVSE 138 may have a charge connector 140 for plugging into a charge port 134 of the vehicle 112. The charge port 134 may be any type of port configured to transfer power from the EVSE 138 to the vehicle 112 and may be electrically connected to a charger or on-board power conversion module 132. The power conversion module 132 may condition the power supplied from the EVSE 138 to provide the proper voltage and current levels to the battery assembly 124. The power conversion module 132 may interface with the EVSE 138 to coordinate the delivery of power to the vehicle 112.

The present invention may be better understood with reference to the following examples.

### Test Methods

Melt Viscosity: The melt viscosity (Pa-s) may be determined in accordance with ISO 11443:2021 at a shear rate of 400 s⁻¹ and using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod was 233.4 mm. The melt viscosity is typically determined at a temperature of 310° C.

Tensile Modulus, Tensile Stress at Break, and Tensile strain at Break: Tensile properties may be tested according to ISO 527-2/1A:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 5 mm/min.

Flexural Modulus and Flexural Stress: Flexural properties may be tested according to ISO 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Notched Charpy Impact Strength: Charpy properties may be tested according to ISO Test No. ISO 179-1:2010) (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C. or −30° C.

Leakage Testing: Leakage testing may be tested in vacuum chamber with helium as tracer gas. The test can be used to inspect complete cells before and after electrolyte filling and sealing. The test pressure may range from 0.1 MPa to 1.0 MPa.

### Materials Employed

“PPS” is a linear polyphenylene sulfide available from Celanese under the designation FORTRON® 0214;
“Bifunctional Polymer” is LOTADER® AX8840 (Arkema), which is a random copolymer of ethylene and glycidyl methacrylate (8 wt. %) having a melt index of 5 g/10 min at 190° C.;
“Epoxy Resin” is EPON™ 1002F (Hexion), which is a solid epoxy resin derived from a liquid epoxy resin and bisphenol-A and that has two (2) moles epoxide groups per mole of resin, an epoxy equivalent weight of 600 to 700 grams per equivalent weight as determined according to ASTM D1652-11(2019), and an epoxy content of from about 55-65 wt. %);
“Zinc Stearate”; and
Lubricant is GLYCOLUBE® P (Lonza).

### Examples 1-4

Various samples are melt mixed using a 32 mm Coperion co-rotating, fully-intermeshing, twin-screw extruder with ten temperature control zones including one at the die. The materials are fed to the main feed throat in the first barrel by means of a gravimetric feeder and then extruded through a strand die. The strands are water-quenched in a bath to solidify and granulated in a pelletizer. The resulting compositions are set forth in more detail in Tables 1-2 below.

TABLE 1

| | Example | | | |
|---|---|---|---|---|
| | 1 | 2 | 3 | 4 |
| PPS (wt. %) | 99.7 | 94.6 | 89.6 | 89.0 |
| Bifunctional Polymer (wt. %) | — | 5 | 10 | 10 |
| (epoxy content of 8 wt. %) | | | | |
| Epoxy Resin (wt. %) | — | — | — | 0.6 |
| (epoxy content of 55-65 wt. %) | | | | |
| Zinc Stearate (wt. %) | — | 0.1 | 0.1 | 0.1 |
| Lubricant (wt. %) | 0.3 | 0.3 | 0.3 | 0.3 |

TABLE 2

| | Example | | | |
|---|---|---|---|---|
| | 1 | 2 | 3 | 4 |
| PPS (parts) | 100 | 100 | 100 | 100 |
| Bifunctional Polymer (parts) | — | 5.3 | 11.2 | 11.2 |
| Epoxy Resin (parts) | — | — | — | 0.67 |
| Zinc Stearate (parts) | — | 0.11 | 0.11 | 0.11 |
| Lubricant (parts) | 0.3 | 0.32 | 0.33 | 0.34 |
| Epoxy Content (parts) | 0.0 | 0.42 | 0.90 | 1.27-1.33 |

Following formation, the samples are tested for a variety of physical characteristics. The results are set forth in Table 3 below.

TABLE 3

| | Example | | | |
|---|---|---|---|---|
| | 1 | 2 | 3 | 4 |
| Melt Viscosity (kP) at 1,200 s⁻¹ | 1.2 | 1.6 | 2.2 | 2.5 |
| Tensile Modulus (MPa) | 3,600 | 10,200 | 14,100 | 15,100 |
| Tensile Strength (MPa) | 85 | 72 | 62 | 160 |
| Tensile Strain at Break (%) | 2.8 | 12.0 | 40.3 | 41.0 |
| Flexural Modulus (MPa) | — | — | 2,800 | — |
| Flexural Strength (MPa) | — | — | 90 | — |
| DTUL at 1.8 MPa (° C.) | — | — | 100 | — |
| Charpy Notched Impact Strength (kJ/m²) at 23° C. | 3 | 16 | 40 | 45 |
| Leakage After Thermal Shock | Yes | No | No | No |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A nonaqueous electrochemical battery comprising:
a housing containing an interior space extending to an open end;
a positive electrode, negative electrode, separator, and electrolyte disposed within the interior space of the housing; and
a sealing member disposed adjacent to the open end of the housing, wherein the sealing member comprises a polymer composition that contains a polyarylene sulfide and a bifunctional polymer that contains an epoxide functional group and a (meth)acrylate functional group, wherein the polymer composition has an epoxy content of from about 0.3 to about 2 parts by weight per 100 parts by weight of polyarylene sulfides in the polymer composition.

2. The nonaqueous electrochemical battery of claim 1, wherein the polymer composition exhibits a notched Charpy impact strength of about 6 kJ/m² or more as determined at a temperature of 23° C. in accordance with ISO 179-1:2010, tensile modulus of about 8,000 MPa or more as determined at a temperature of 23° C. in accordance with ISO 527:2019, and/or melt viscosity of about 5 kP or less as determined in accordance with ISO 11443:2021 at a temperature of about 310° C. and at a shear rate of 1,200 s⁻¹.

3. The nonaqueous electrochemical battery of claim 1, wherein polyarylene sulfides constitute from about 60 wt. % to about 99 wt. % of the polymer composition.

4. The nonaqueous electrochemical battery of claim 1, wherein the polyarylene sulfide is a polyphenylene sulfide.

5. The nonaqueous electrochemical battery of claim 4, wherein the polyarylene sulfide is a linear polyphenylene sulfide.

6. The nonaqueous electrochemical battery of claim 1, wherein the bifunctional polymer contains a monomeric unit derived from an epoxy-functional (meth)acrylate.

7. The nonaqueous electrochemical battery of claim 6, wherein the bifunctional polymer further includes a monomeric component derived from an α-olefin.

8. The nonaqueous electrochemical battery of claim 7, wherein the copolymer further contains a monomeric unit derived from a (meth)acrylate that is not epoxy-functional.

9. The nonaqueous electrochemical battery of claim 1, wherein bifunctional polymers constitute from about 2 to about 15 parts by weight per 100 parts by weight of the polyarylene sulfides employed in the polymer composition.

10. The nonaqueous electrochemical battery of claim 1, wherein the polymer composition is generally free of reinforcing fibers.

11. The nonaqueous electrochemical battery of claim 1, wherein the polymer composition is generally free of mineral fillers.

12. The nonaqueous electrochemical battery of claim 1, wherein the polymer composition further contains an epoxy resin.

13. The nonaqueous electrochemical battery of claim 12, wherein the epoxy resin has an epoxy equivalent weight of from about 250 to about 1,500 grams per gram equivalent as determined in accordance with ASTM D1652-11e1 (2019).

14. The nonaqueous electrochemical battery of claim 1, wherein the electrolytes includes a lithium salt dissolved in a nonaqueous organic solvent.

15. The nonaqueous electrochemical battery of claim 1, wherein the positive electrode includes a positive electrode active material optionally disposed on a current collector and the negative electrode includes a negative electrode active material optionally disposed on a current collector.

16. The nonaqueous electrochemical battery of claim 15, wherein the positive electrode active material includes a lithium-containing metal oxide.

17. The nonaqueous electrochemical battery of claim 15, wherein the negative electrode active material includes lithium or an alloy thereof, a carbonaceous material, or a combination thereof.

18. The nonaqueous electrochemical battery of claim 1, further comprising a cover that is disposed over the housing.

19. The nonaqueous electrochemical battery of claim 18, wherein the cover contains the sealing member.

20. The nonaqueous electrochemical battery of claim 18, further comprising a gasket that is positioned between the housing and the cover, wherein the gasket includes the sealing member.
